(19) United States
(12) Patent Application Publication
(10) Pub. No.: US 2014/0132963 A1
(43) Pub. Date: May 15, 2014

(54) Optical personal Locating device

(71) Applicant: Vicente Diaz, Madrid (ES)

(72) Inventor: Vicente Diaz, Madrid (ES)

(21) Appl. No.: 14/081,468

(22) Filed: Nov. 15, 2013

Related U.S. Application Data
(60) Provisional application No. 61/726,926, filed on Nov. 15, 2012.

(51) Int. Cl. G01B 11/02

(52) U.S. Cl. CPC G01B 11/026
USPC 356/614

(57) ABSTRACT

The present disclosure is a locating device using light to locate other similar devices in a given place with respect to each other where other techniques are not possible to be used. The present disclosure presents a first communication device comprising a light receiving unit, wherein said first communication device is configured to generate a code, transmit said code, and receive a pulse signal from a second communication device. The first communication device is configured to communicate through a network with said second communication device, wherein said second communication device is configured to receive said code, transmit the pulse signal based on said code and modulate the light emitted by a light emitting source.

### RELATED APPLICATIONS

This application is related to provisional U.S. Patent Application no. 61/726926 filed on Nov. 15, 2012.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISK APPENDIX

N/A

### FIELD OF THE DISCLOSURE

The present disclosure is in the technical field of personal locating devices. More particularly, the present disclosure is in the technical field of portable optical locating devices.

### BACKGROUND OF THE DISCLOSURE

Conventional locating devices, such as GPS locating devices, radio location devices, and the like, are typically based on either radio propagation characteristics by means of a network of beacons or a network of satellites transmitting reference signals to the device in order to be located in space or coordinates (x, y, z). Furthermore, those devices are generally designed for outdoor locations; so when users are indoors there are difficulties in locating the devices' position.

Another way of locating someone or something is using light. There are many systems using light for locating purposes, like infrared Laser. Laser measures distances so locating an object is straightforward. Nevertheless, this method requires special hardware and it could be dangerous for people because Laser can damage their eyes. On the other hand, visible light, which is used in this disclosure, is harmless and can be used to locate objects or people having direct sight with a light reference indoors. In order to achieve this, the device to be located must generate information and modulate a light source (like a flash light) that is transmitted through the air and is demodulated by a camera or any visible light detection system on a locating device in order to locate the source of the device to be located. This process can be seen as a light communication process that will also need spatial references or beacons. These kinds of communications are usually called Visible Light Communications (VLC). VLC have existed since humans discovered how to control fire and it has been used with great success in positioning ships by means of lighthouses, military signaling and the like.

More recently, IEEE 802.15 WPAN Task Group 7 has completed a physical layer and Medium Access Controller layer for broadband communications. A similar application of this concept is used by company pureVLC with its light message application for sending text messages to mobile phones at short distances. Another feature for positioning objects can be seen in the Casio PicapiCamera iphone application where, by using simple codes (circles, squares and other geometrical drawings) in a mobile phone display, another mobile phone can track its position near it (in the order of 2 meters or so). Similarly, Nintendo 3DS does the same with specially designed cartoon cards that are used to locate the position of characters during games.

Another example is the MIT Media Labs NewsFlash project that embeds information on screen images through a process that is imperceptible to the human eye and helps other devices detect such information to be applied in augmented reality applications.

Nowadays most devices use beacons as a reference to locate the exact positioning of, for instance, blind people as in Shaifur et al “Indoor Positioning by LED Visible Light Communication and Image Sensors”.

Another technology for pinpointing an exact location within a building is called ByteLight. The Bytelight technology is based on indoor beacons modulating light sources by means of light communication chips embedded inside lamps. Using two or three light emitting sources, such as lamps, directly detected by the mobile device comprising particular software, the mobile device can detect accurately its position with respect to the indoor lamps. At the time of the redaction of this document there are no public patent or information of such a system but there are other related patents like the Perkins' patent U.S. Pat. No. 6,865,347 that also uses the information of data sent by modified lamps indoors. Said patent also mentions different patents relating to but different from it. In fact Perkins' explains that a modulation device must be added in series with the lamp in order to provide such features and that it uses at least one lamp and its location in order to locate the receiver.

However, none of the examples above help people find or locate one another by transmitting information on the relative position of where they are with respect to each other without the aid of beacons. In fact, the main difference of the present disclosure with respect to any other patent is that it does not need a beacon or a beacon network to locate any receiver.

A difficult environment for location applications is during special events like concerts, disco clubs and dark environments when noise, low radio signal and reduced mobile coverage do not permit vocal communication or pinpointing a location. Moreover, high-speed data transmission is not needed for this application because no real time information has to be sent from one another, so it reduces the need of special, modified or high-end hardware reducing costs and increasing sensitivity. Another example in which pinpointing an exact location is difficult is when people go to crowded events. In these satiations it may be difficult for people to locate their friends or family when arriving late to the event. Thus, a locating device is needed in order to aid people find other in dark and noisy places or where other location services are not available.

### SUMMARY OF THE DISCLOSURE

The present disclosure is a locating device for users intended to locate other users with similar devices in places where location services are not available, especially in dark, noisy or very harsh places.

It is another object of the present disclosure to provide means to eliminate or reduce the need of light emitting infrastructure. In accordance with the principles of the present disclosure the locating device uses the light emitted by other mobile devices to determine the location of said other mobile devices (located devices) with respect to the locating device.

Another object of this disclosure is to provide a computing platform that uses a sequence of instructions in order to generate codes, analyze received signal and determined located device positions.

Still another object of the present disclosure is to provide means for detecting the relative position of a device with respect to at least one of the transmitters. In accordance with the principles of the present disclosure the locating device does not need to use a 3D optical receiver as it positions other transmitters by means of moving the receiver in the x,y,z planes using the mobile embedded camera.

Another object of this disclosure is to provide a means to avoid using time delay or time of arrival (ToA) in order to know the relative position. In accordance with the principles of the present disclosure the locating device does not measure neither delays nor ToA but it uses flashing light (transmitter blinking) position on screen (camera) to know where the other devices are with respect to the locating device by moving said locating device upon the instructions received from the software embedded in the mobile device by means of signs or arrows.

It is another object of the present disclosure to provide means to determine the location of devices independent of flickers in the light emitted by the light emitted source. In accordance with the principles of the present disclosure the locating device locates other similar devices relative to its position without using neither any infrastructure nor delays and using frequency modulated light, such as blinking pattern at frequencies that could be visible or not to humans.

Yet another object of the present disclosure is to provide means for avoiding modifying lamps at light emitting devices in order to provide the location feature. In accordance with the principles of the present disclosure the light emitting devices uses pre-existing light emitting features, such as camera flash and/or screen backlight in order to provide its position information with respect to the locating device as the receiver device.

Furthermore, another object of the present disclosure is to detect light located in the receiver screen of a mobile phone in order to position the transmitter into the screen not using a fixed reference. The present disclosure locates others from the locating device's current position and by changing locating device's position the device can find other transmitters' position relative to the locating device. This method is the opposite of any other current location system. The present disclosure works to the contrary of a GPS system, that is like locating GPS satellites with respect to the present device assuming that satellites do not maintain their relative position nor fixed position among them. In order to track any satellite you should move your receiver following your device instructions continuously pointing to such satellite.

### BRIEF DESCRIPTION OF THE DRAWINGS

FIG. 1 is a diagram showing a user of a locating device locating a user of a located device, according to a preferred embodiment of the disclosure.

FIG. 2 is a diagram showing the structure for software application embedded in the locating device and located device, according to a preferred embodiment of the disclosure.

FIG. 3 is a diagram showing the structure for locating the located device, according to a preferred embodiment of the disclosure.

FIG. 4a is a diagram showing the 3D view of a locating device detecting the located device, according to a preferred embodiment of the disclosure.

FIG. 4b shows the video screen of the locating device instructing a user where to move in order to locate the located device, according to a preferred embodiment of the disclosure.

FIG. 4c shows the video screen shown in FIG. 4b after the located device has been located.

### DETAILED DESCRIPTION OF THE DISCLOSURE

Referring now to the disclosure in more detail, the present optical locating device system comprises at least a first communication device or locating device 3 and second communication device or located device 4. The locating device 3 comprises a programmable device, such as a personal computer, mobile device or any other device having computation characteristics that connects or communicates through a network, such as a LAN, WAN, intranet or the Internet. The locating device 3 comprises a computing platform. The computing platform includes a set of instruction for several alternatives or options to initiate the locating process. Further the first communication device 3 include an image or light acquisition unit, such as a video camera, an image display unit, such as a screen, a controlled light emitting unit, such as a controlled light or flash, and a input transducer for the first communication device, such as keyboard interface or touch screen.

Furthermore, the located device 4 comprises a programmable device, such as a personal computer, mobile device or any other device having computation characteristics that connects or communicates through a network, such as a LAN, WAN, intranet or the Internet. The located device 4 comprises a computing platform. The computing platform includes a set of instruction for several alternative or options to initiate the locating process. Further the second communication device 3 include an image or light acquisition unit, such as a video camera, an image display unit, such as a screen, a controlled light emitting unit, such as a controlled light or flash, and a input transducer for the second communication device, such as keyboard interface or touch screen.

Once the locating device 3 initiates the locating process through a set of instructions at the computing platform, the located device 4 sends an optical encoding signal back to the locating device in order to be located. The locating device 3 and/or the located device 4 are used interchangeably in the process as they can start the locating process indistinctively. The disclosure can be built as an optical locating device or as a set of instructions embedded on the communication devices.

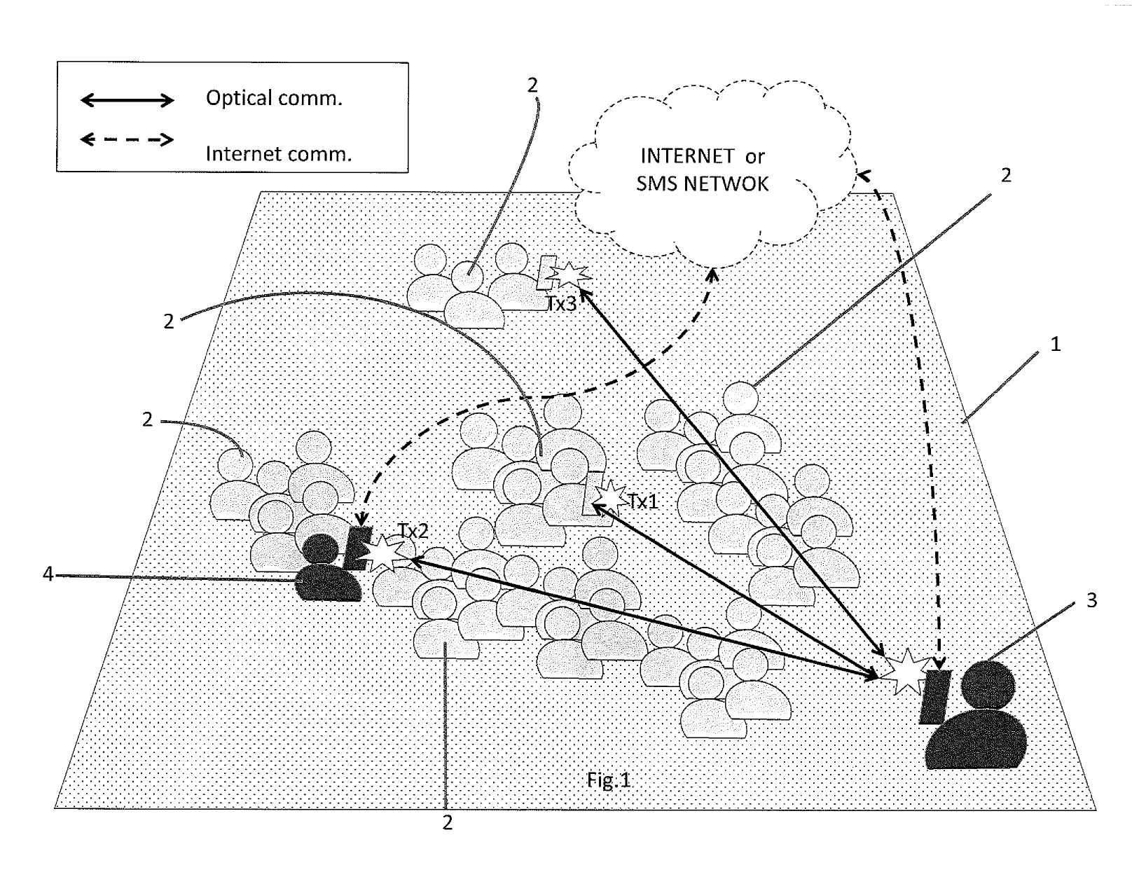

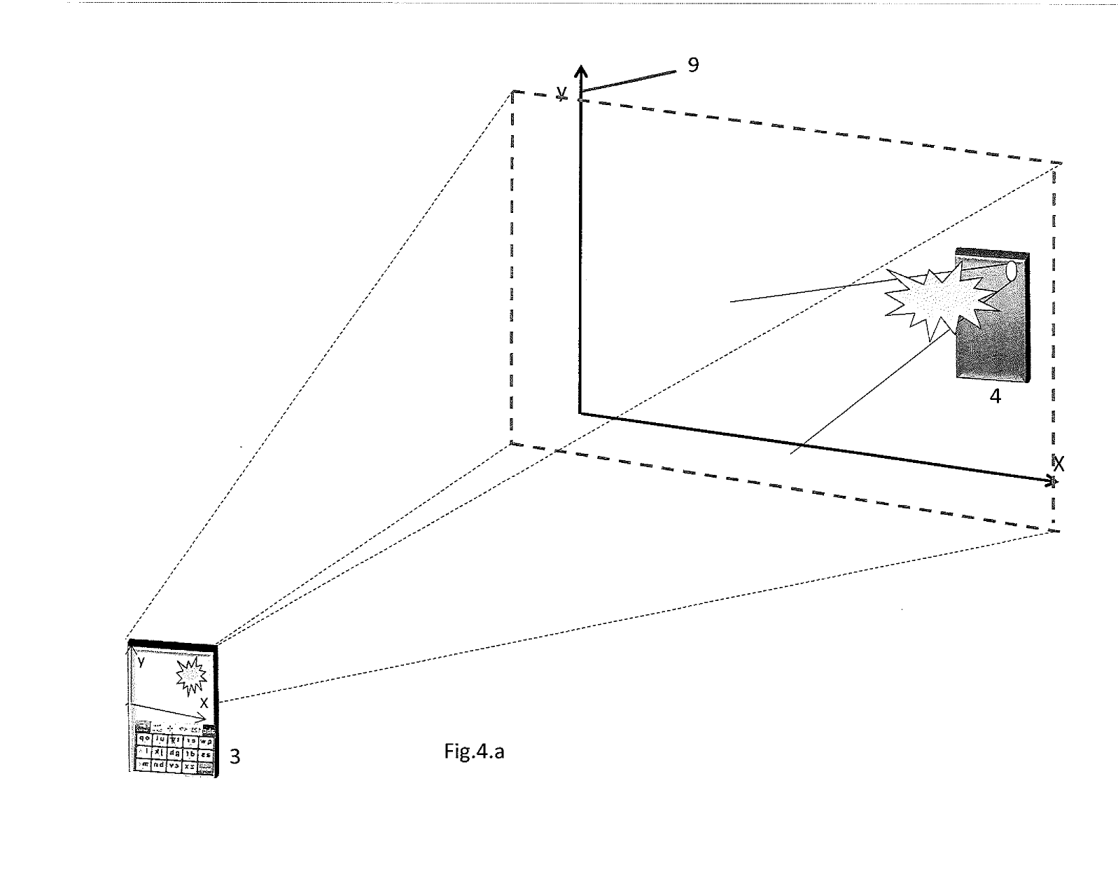

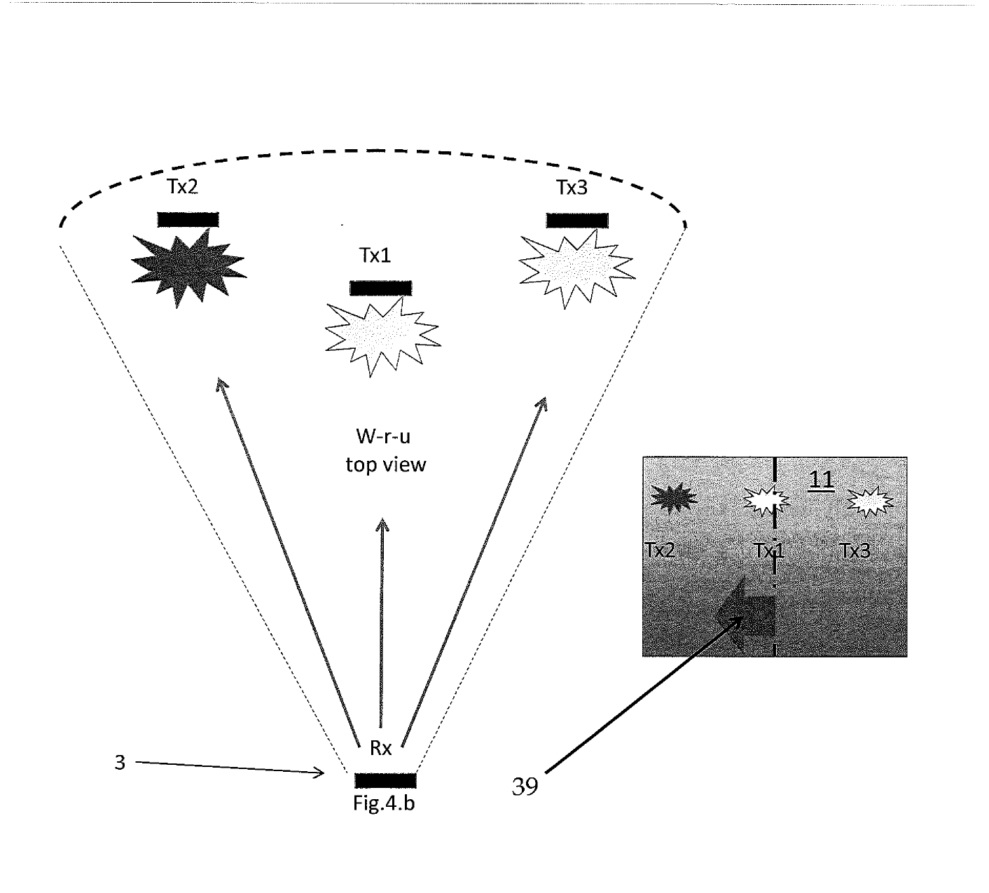

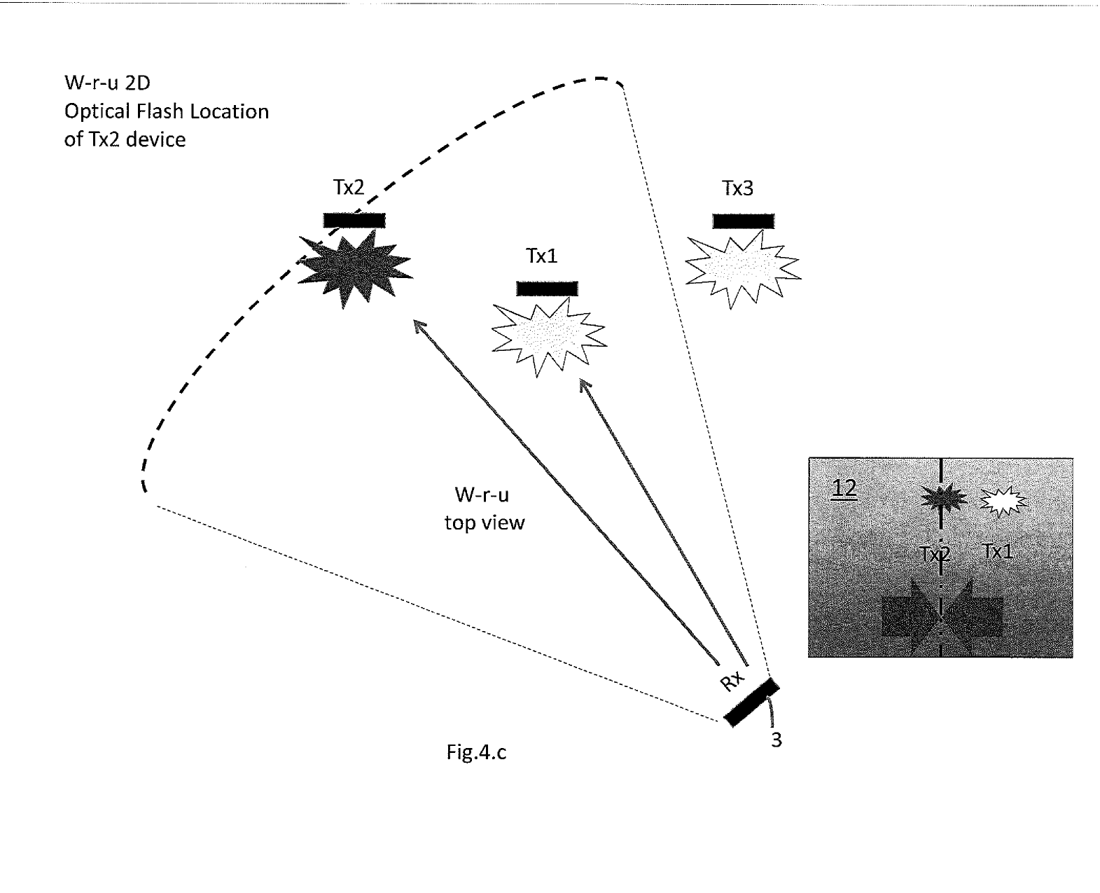

In order to clarify how the disclosure works, specifically in FIG. 1 there is shown a room 1 or site with many people inside, some of them handling devices with the functions defined in this application. In FIG. 1 the locating user 3 wants to locate a friend 4 in the room. The location process is initiated by using a data connection to the Internet. The procedure starts with the simple gesture of activating the function in the locating device 3 and then positioning the device screen in front of the user's eyes moving it around while the screen shows indications on where to position the device, these indications are used as a correction procedure for user, as explained in FIGS. 4.a to 4.c, moving device left/right and up/down in order to center the located device. An optical link is also provided with the surrounded devices in order for the procedure to work.

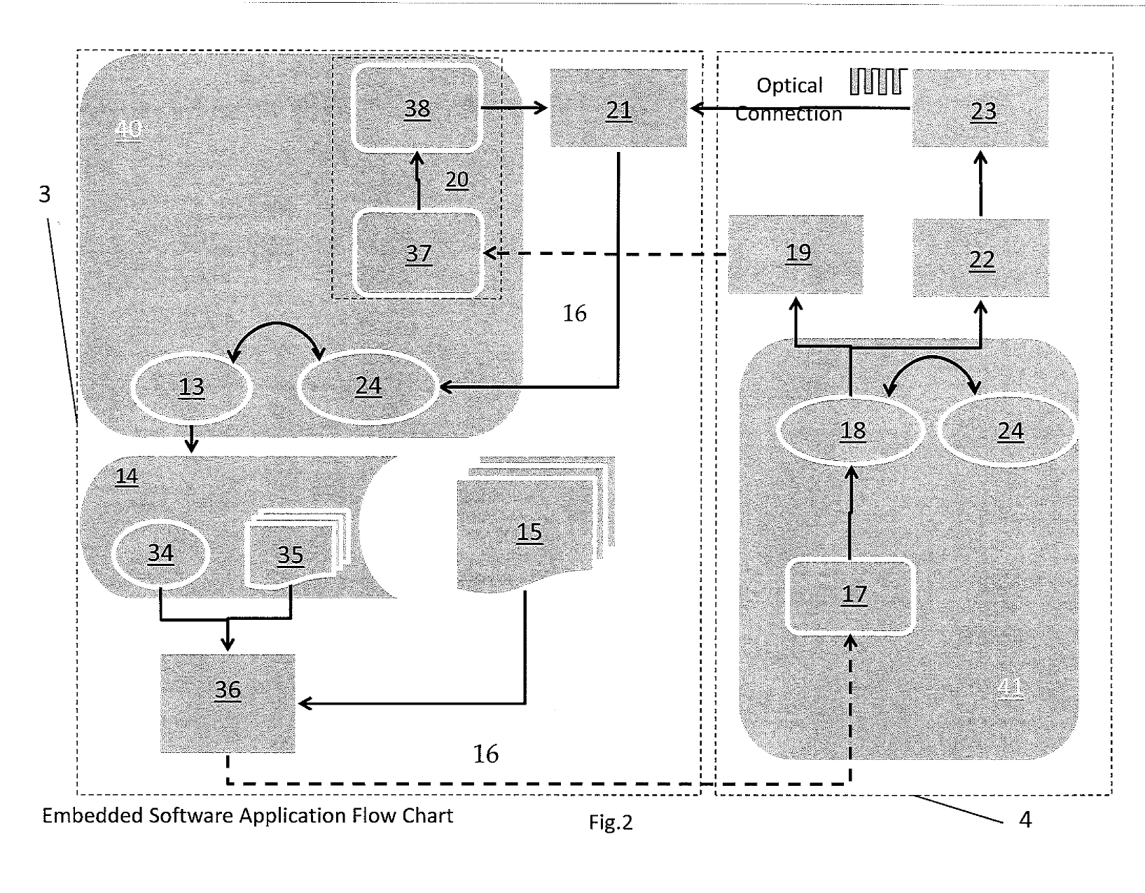

Both the locating device and located device include an embedded software application as described in FIG. 2. It should be noted that the user of the locating device 3 may be connected or not to a social network account to try to locate the located device 4 inside a certain area. In order to locate the located device's user the locating user must first push the activate button 13. This action activates a selection screen 14 in order to select the contact information of friends to be located from a phonebook or friends' list. It should be noted that friends must be visible in order to be located. After selecting the people to be located, a code message is automatically selected from a code database 15 that can be located in the device or a server outside the device via the Internet. The code is assigned to the destination users and is sent simultaneously with a message of acceptance 16 called wer-u message, to destination users through the available Internet connection or SMS mobile network.

When the wer-u message 17 is received, the user must acknowledge and accept to be located by pushing the accept button 18. After accepting, an acknowledgement message 19 is sent back through the available Internet connection or SMS mobile network and received by the locating device 20 thereby activating the optical receiver section 21, which is in charge of helping user locate a friend using the device screen and camera. Simultaneously, the located device starts generating the code transmission 22 that is emitted by using the optical transmission section 23. It should be noted that at any time, either locating or located users can deactivate this process by pushing the deactivate button 24.

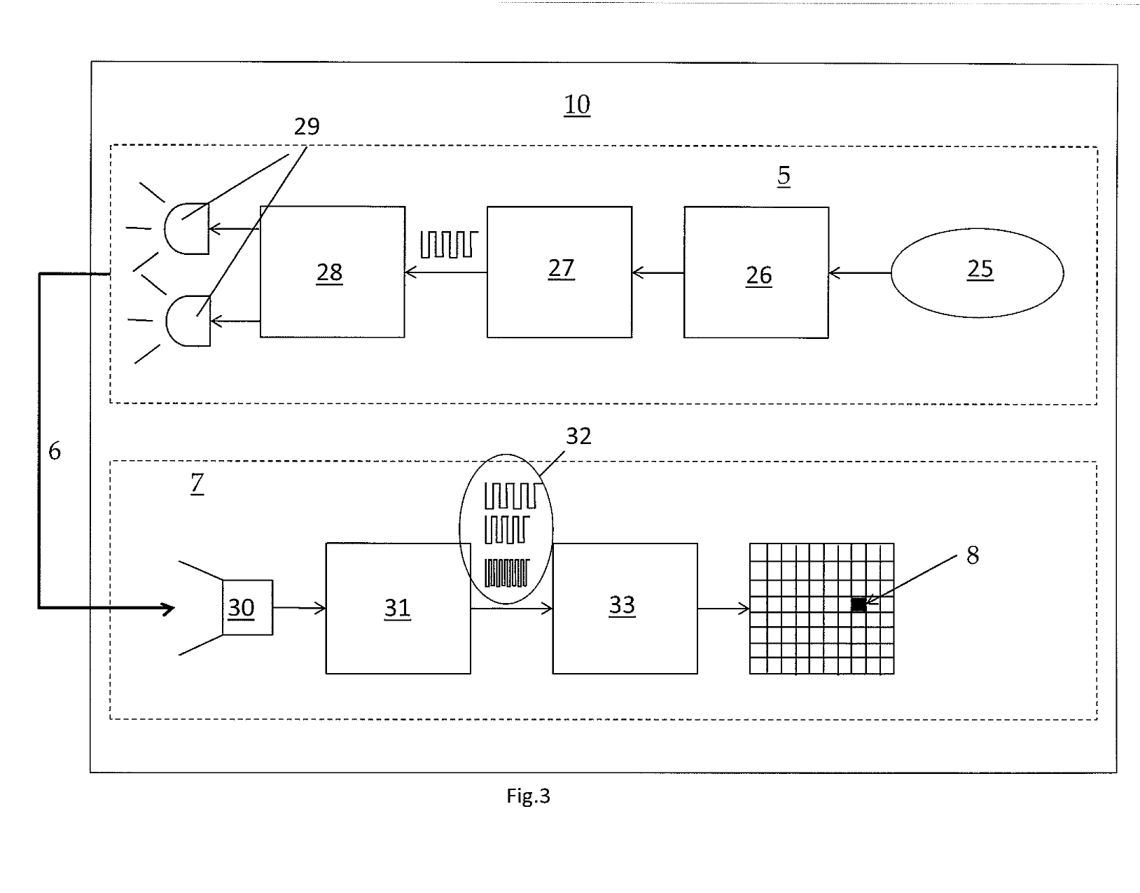

The processes involved in the optical receiver section 21 and optical transmitter section 23 are described in more detail in FIG. 3 which shows a diagram of the optical process initiated by the located device 5 that sends a light modulated code 6 received by the locating device 7 that is translated into a screen position 8. The process initiates with a start pulse signal 25 that is fed to a pulse encoder 26 that generates an encoded pulse that is modulated by using amplitude, frequency or phase modulation 27 in order to be fed to a Light Emitting Diode (LED) based torch or screen backlight controller 28. The controller is in charge of switching on and off at the rate and modulation technique established by the signal modulator 27 and feeding the signal to an LED or back light 29. The simplest implementation of this signal is using a switching frequency selected from a set of frequencies different from one another in the vicinity in order not to interfere with other devices in crowded places.

In the optical receiver section 21, the locating device receives the encoded optical signal 6 by using a camera 30 whose images are fed to an image camera processor 31 obtaining the encoded optical pulses 32 in a 2D matrix referring to the position x,y in the camera device that are decoded by, for instance, a 2D FFT process 33, obtaining peaks of detection when located code matched the locating code. The codes are translated directly into the equivalent x,y detected position in the screen matrix 8 that is visualized by locating user and used to correct target position.

FIG. 4a is a perspective 3D view of a locating device 3 featuring the detection of the located device 4 flashing an identifying code back in its spatial coordinates in the real x,y plane 9 corresponding to an equivalent x,y point in the screen of the locating device 3

The process of locating a given device is detailed in FIG. 4b where the locating device Rx is trying to locate located device Tx2. Here, a plurality of located devices Tx1, Tx2, Tx3 (with different codes each) are positioned within the video screen 11 of locating device Rx having Tx2 at the left side of the screen as indicated in the screen (right picture) by a red arrow suggesting the user to rotate to the left in order to locate Tx2.

FIG. 4c shows the resulting position of the locating device Rx after moving said locating device 3 to the direction in which the located device Tx2 is located. The located device Tx2 is now in the center point of the screen indicating a location match state by means of two pointing arrows in the middle of it.

The advantages of the present disclosure include, without limitation that it is portable, does not need of any other locating external device, like beacons, GPS or the like, and it is simple to use and read for any unskilled person. It is also easy to implement by a software application, for example, in current mobile devices having the required hardware: a camera, a controlled flash or light, a screen and a keyboard or touch screen.

The disclosure is not limited to the precise configuration described above. While the disclosure has been described as having a preferred design, it is understood that many changes, modifications, variations and other uses and applications of the subject disclosure will, however, become apparent to those skilled in the art without materially departing from the novel teachings and advantages of this disclosure after considering this specification together with the accompanying drawings. Accordingly, all such changes, modifications, variations and other uses and applications which do not depart from the spirit and scope of the disclosure are deemed to be covered by this disclosure as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present disclosure, as well as equivalents thereof. The details in the patents, patent applications, and publications incorporated by reference herein may be considered to be incorporable at applicant's option, into the claims during prosecution as further limitations in the claims to patently distinguish any amended claims from any applied prior art.

What is claimed is:

1. An optical locating system comprising:
a network;
a first communication device comprising a light receiving unit and a first computer platform including a first processor and a first set of machine-readable instructions wherein said first set of machine-readable instructions are configured to generate a code, transmit said code, and receive a pulse signal;
a second communication device comprising a light emitting source, a pulse emitting generator, and a second computer platform including a second processor and a second set of machine-readable instructions;
wherein said first communication device is configured to communicates through a network with said second communication device; and
wherein said second set of machine-readable instructions is configured to receive said transmitted code, transmit the pulse signal based on said code and modulate the light emitted by the light emitting source.

2. The optical locating system of claim 1 wherein said first communication device comprises a pulse frequency decoder and a display unit, wherein the first set of machine-readable instructions is configured to receive said pulse signal using said light receiving unit, decode said pulse signal and display an image at the display unit based on the decoded pulse signal.

3. The optical locating system of claim 1 wherein the first set of machine-readable instructions is configured to use its position in an x, y, z axis to locate the position of the second communication device.

4. The optical locating system of claim 1 wherein the first set of machine-readable instructions is configured to give directions on the display unit to locate the position of the second communication device.

5. The optical locating system of claim 1 wherein the pulse signal is an optical pulse signal.

6. The optical locating system of claim 1 wherein the pulse signal is a visible light digitally modulated in amplitude, phase and frequency by using said code.

7. The optical locating system of claim 1 wherein the first communication device is a mobile device.

8. The optical locating system of claim 7 wherein the first communication device includes a first keyboard and a first touch screen.

9. The optical locating system of claim 1 wherein the second communication device is a mobile device.

10. The optical locating system of claim 10 wherein the second communication device includes a second keyboard and a second touch screen.

11. The optical locating system of claim 1 wherein the first communication device and second communication device communicate with each other through a data network in order to exchange coded messages.

12. The optical locating system of claim 12 wherein the coded messages are sent through a light pulse signal between the first communication device and the second communication device.

13. The optical locating system of claim 12 wherein the coded messages are sent through a text messaging service.

14. The optical locating system of claim 12 wherein the coded messages are sent through a social network.

15. A method of locating the located device comprising:
a network;
a first communication device comprising a light receiving unit and a first computer platform including a first processor and a first set of machine-readable instructions;
a second communication device comprising a light emitting source, a pulse emitting generator, and a second computer platform including a second processor and a second set of machine-readable instructions;
wherein the first communication device assists with the location of said second communication device comprising the steps of
the first communication device generating a code, wherein said code is related to a predetermined pulse signal parameters and said pulse signal parameters are stored at said first communication device;
the first communication device sending said code to a second communication device through said network;
the second communication device receiving said code;
said code being accepted by the second computer platform;
said second computer platform generating a pulse signal, wherein said pulse signal is transmitted through the light emitting source;
the first communication device detecting said pulse signal by means of the light receiving unit;
decoding the pulse signal received and comparing said pulse signal with the stored pulse parameters; and
indicating on the display unit of the first communication device the position of the second communication device wherein the decoded pulse signal matches said stored pulse signal.

16. The method of claim 15, wherein said first communication device comprises a display unit, and wherein first communication device displays an image on the display unit based on the decoded pulse signal.

17. The method of claim 16, wherein the first communication device marks the position in the x, y, z, axis with respect to the current position of the first communication device.

18. The method of claim 15, wherein the light receiving unit captures images at a given rate in frames per second and detects the light emitted by the light emitting source from the second communication device.

19. The method of claim 15, wherein the pulse signal is a visible light pulse signal.

20. The method of claim 15, wherein the pulse parameters include frequency, amplitude and phase.
